(19) United States
(12) Patent Application Publication
(10) Pub. No.: US 2011/0026897 A1
(43) Pub. Date: Feb. 3, 2011

(54) Video Recording Devices and Video Recording Methods

(76) Inventor: Justin Mark Sobaje, Los Angeles, CA (US)

Correspondence Address: Justin Mark Sobaje, 4655 E. Shepherd, Clovis, CA, 93619, US

(21) Appl. No.: 12/848,529

(22) Filed: Aug. 2, 2010

Related U.S. Application Data
(60) Provisional application No. 61/230,758, filed on Aug. 3, 2009.

(51) Int. Cl. H04N 5/77; H04N 5/92; H04N 5/928; H04N 5/775

(52) U.S. Cl. 386/224; 386/337; 386/338; 386/230; 386/E05.069; 386/E05.02; 386/E05.021; 386/E05.07

(57) ABSTRACT

A video recording device includes imaging circuitry, processing circuitry, and communication circuitry. The imaging circuitry is configured to generate image data for a scene being imaged. The processing circuitry is configured to generate first video data using the image data. The communication circuitry is configured to wirelessly send the first video data to another video recording device and to wirelessly receive second video data from the other video recording device. The processing circuitry is further configured to controllably switch during a recording of a video from storing portions of the first video data as part of the video to storing portions of the second video data as part of the video.

### CROSS-REFERENCE TO RELATED PATENT APPLICATIONS

This application claims the benefit of U.S. Provisional Patent App. Ser. No. 61/230,758, entitled “Video Recording Devices and Video Recording Methods”, filed Aug. 3, 2009, the entire contents of which are incorporated by reference herein.

### SUMMARY OF THE DISCLOSURE

A video recording device in accordance with an embodiment of the present invention includes imaging circuitry, processing circuitry, and communication circuitry. The imaging circuitry is configured to generate image data for a scene being imaged. The processing circuitry is configured to generate first video data using the image data. In various embodiments, the communication circuitry is configured to wirelessly send the first video data directly to another video recording device and to wirelessly receive second video data directly from the other video recording device. The processing circuitry is further configured to controllably switch during a recording of a video from storing portions of the first video data as part of the video to storing portions of the second video data as part of the video.

In various embodiments, the video recording device includes audio circuitry that is configured to generate audio data for the first video data. Also, in various embodiments, the video recording device includes a display that is operable to display images of the first video data and the second video data at a same time in a split screen mode. In some embodiments, the video recording device includes a storage device for storing the video.

In various embodiments, the video recording device includes an input device for receiving commands to control the processing circuitry. Also, in various embodiments, the processing circuitry is configured to switch between storing portions of the first video data as part of the video to storing portions of the second video data as part of the video based on a command received by the input device. In some embodiments, the processing circuitry is configured to switch between storing portions of the first video data as part of the video to storing portions of the second video data as part of the video based on a command received by the communication circuitry. Also, in some embodiments, the command to switch is received by the communication circuitry from the other video recording device.

In various embodiments, the communication circuitry is configured to receive the second video data while the imaging circuitry generates the image data. Also, in various embodiments, the video recording device is configured to be synchronized with the other video recording device. In further embodiments, the first video data and the second video data include timestamps. In some embodiments, the communication circuitry is configured to wirelessly send the first video data directly to two or more video recording devices at a same time. In various embodiments, the video recording device is a hand-held video camera. Also, in various embodiments, the video recording device is a cellular phone.

A method of using a video recording device in accordance with an embodiment of the present invention includes generating image data using imaging circuitry of the video recording device, generating first video data from the image data, wirelessly sending the first video data directly to another video recording device at a same time as wirelessly receiving second video data directly from the other video recording device using communication circuitry of the video recording device, and controllably switching during a recording of a video from storing portions of the first video data as part of the video to storing portions of the second video data as part of the video.

A method of using a video recording device in accordance with another embodiment of the present invention includes generating image data using imaging circuitry of the video recording device, generating first video data from the image data, wirelessly sending the first video data indirectly through a network to another video recording device at a same time as wirelessly receiving second video data indirectly through the network from the other video recording device using communication circuitry of the video recording device, and controllably switching during a recording of a video from storing portions of the first video data as part of the video to storing portions of the second video data as part of the video.

### BRIEF DESCRIPTION OF THE DRAWINGS

FIG. 1 illustrates a system in accordance with an embodiment of the present invention with a first video recording device and a second video recording device;

FIG. 2 illustrates an example in which a system in accordance with an embodiment of the present invention is used to create a video of a scene;

FIG. 3 illustrates an example in which a system in accordance with another embodiment of the present invention is used to create a video of a scene;

FIG. 4 illustrates a flowchart of a method in accordance with an embodiment of the present invention for storing video data for a video; and

FIG. 5 illustrates an example of a system in accordance with another embodiment of the present invention in which three video recording devices are used to make a video of a scene.

### DETAILED DESCRIPTION OF PREFERRED EMBODIMENTS

Various embodiments of the present invention allow for creating a video using a video recording device, such as a hand-held video camera, a cellular phone with a built-in video camera, or the like, in which the video recording device is able to switch during a recording process from storing video data generated by the video recording device to storing data received by the video recording device from another video recording device. This allows for multiple video recording devices to image a scene at a same time, and for a video to be produced in real-time at any of the multiple video recording devices that cuts between video from the different video recording devices based on commands from one or more users.

Such embodiments could be used, for example, by friends who are making a video of a scene. Each friend could have their own video recording device, and could be imaging the scene from a respective vantage point. During the time of shooting the video, one or more of the video recording devices could receive video data from the other video recording devices, and switch among storing video data for the video from the various sources in accordance with one or more commands specified by the friends. This would allow for storing a video at any of the video recording devices with the video having real-time cuts between video data for the different vantage points. Thus, a video could be stored in real-time at a video recording device that switches between different views of a scene being imaged by using video data from other video recording devices that are imaging the scene at the same time.

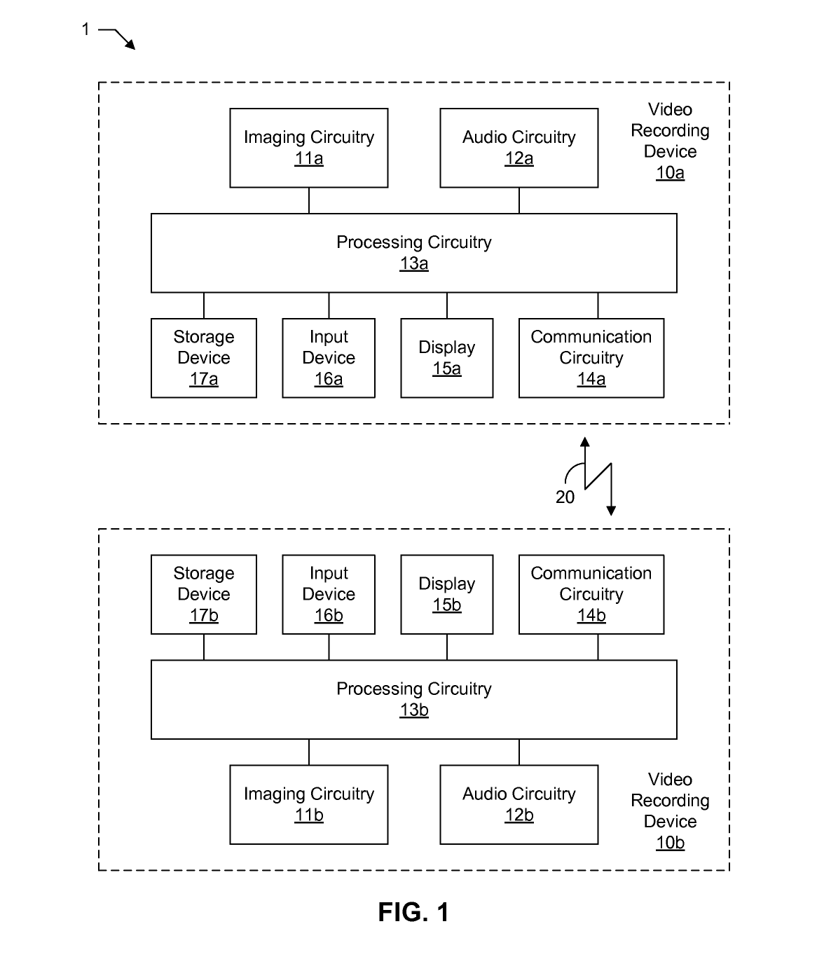

FIG. 1 illustrates a system 1 in accordance with an embodiment of the present invention with a first video recording device 10a and a second video recording device 10b. The first video recording device 10a may be, for example, a hand-held video camera, a cellular phone with video capability, or the like. In various embodiments, the first video recording device 10a comprises imaging circuitry 11a, audio circuitry 12a, processing circuitry 13a, communication circuitry 14a, a display 15a, an input device 16a, and a storage device 17a.

In various embodiments, the imaging circuitry 11a provides image data of a scene being imaged to the processing circuitry 13a. In some embodiments, the imaging circuitry 11a comprises an image sensor with a plurality of pixels for sensing light from a scene being imaged and for providing pixel values as image data to the processing circuitry 13a. In various embodiments, the audio circuitry 12a provides audio data to the processing circuitry 13a. In some embodiments, the audio circuitry 12a comprises a microphone, or the like, and captures analog audio waves and converts the analog audio waves to digital audio data to be provided to the processing circuitry 13a.

In various embodiments, the communication circuitry 14a receives video data from one or more external sources and provides the received video data to the processing circuitry 13a. The video data received by the communication circuitry 14a may include image data and/or audio data. In various embodiments, the communication circuitry 14a comprises a transceiver, or the like, for transmitting and receiving data. In some embodiments, the communication circuitry 14a comprises a wireless networking device, such as an IEEE 802.11 device, a Bluetooth device, or the like, for communicating with other wireless communication enabled devices and/or network devices.

In various embodiments, the display 15a includes a screen for displaying video data to a user. In some embodiments, the display 15a comprises a liquid crystal display (LCD), or the like, for displaying video data. In various embodiments, the input device 16a comprises buttons, switches, knobs, or the like, for receiving user input. In some embodiments, the display 15a may be a touch display and may be used as the input device 16a to receive input from a user. In some embodiments, the display 15a may allow for split screen operation to display video data from more than one source on respective sections of the display 15a at a same time.

In various embodiments, the storage device 17a allows for storing video data. In some embodiments, the storage device 17a comprises a solid-state memory, such as a flash stick, random access memory, or the like, for storing data. Also, in some embodiments, the storage device 17a comprises a hard disk drive, or the like.

In various embodiments, the processing circuitry 13a is configured to receive image data from the imaging circuitry 11a and audio data from the audio circuitry 12a and to generate video data from the image data and the audio data. In some embodiments, the processing circuitry 13a provides video data to the communication circuitry 14a to be transmitted to external devices. Also, in some embodiments, the processing circuitry 13a receives video data from the communication circuitry 14a that has been received from external devices. In various embodiments, the processing circuitry 13a is configured to provide video data to the display 15a to be displayed to a user. In some embodiments, the processing circuitry 13a is configured to use the display 15a as a split screen to display video data from different sources at a same time on respective sections of the display 15a.

In various embodiments, the processing circuitry 13a receives input from the input device 16a that specifies a recording command. In some embodiments, the recording command may indicate that (i) video data generated by the processing circuitry 13a from data obtained from the imaging circuitry 11a and the audio circuitry 12a is to be stored in the storage device 17a; (ii) video data received by the communication circuitry 14a from an external device is to be stored in the storage device 17a; or (iii) the storage of video data to the storage device 17a is to be stopped. In various embodiments, recording commands may also be received by the communication circuitry 14a from external devices and provided to the processing circuitry 13a. The processing circuitry 13a is configured to carry out the commands specified by the recording commands received from the input device 16a and/or the communication circuitry 14a.

In various embodiments, the second video recording device 10b comprises imaging circuitry 11b, audio circuitry 12b, processing circuitry 13b, communication circuitry 14b, a display 15b, an input device 16b, and a storage device 17b. In various embodiments, the second video recording device 10b is similar to the first video recording device 10a, where the imaging circuitry 11b, the audio circuitry 12b, the processing circuitry 13b, the communication circuitry 14b, the display 15b, the input device 16b, and the storage device 17b are similar to the imaging circuitry 11a, the audio circuitry 12a, the processing circuitry 13a, the communication circuitry 14a, the display 15a, the input device 16a, and the storage device 17a, respectively.

In various embodiments, the communication circuitry 14a of the first video recording device 10a can be used to receive video data generated by the second video recording device 10b. Also, in various embodiments, the communication circuitry 14b of the second video recording device 10b can be used to receive video data generated by the first video recording device 10a. The communication between the first video recording device 10a and the second video recording device 10b is illustrated by a double arrow 20 in FIG. 1.

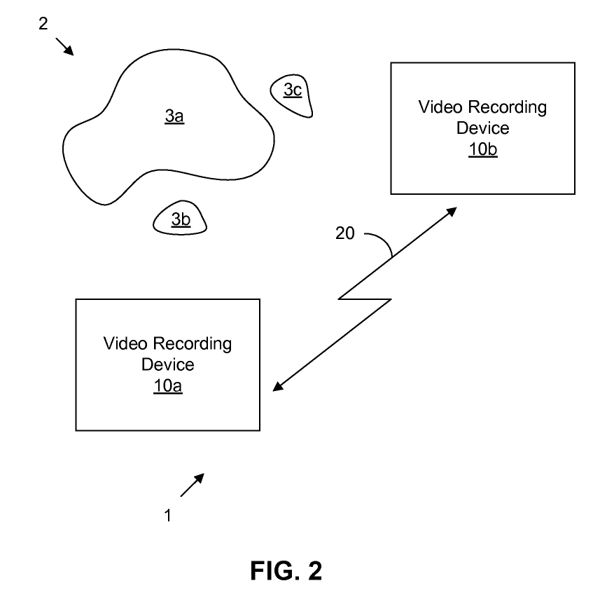

FIG. 2 illustrates an example in which the system 1 is used to create a video of a scene 2. In the example, the scene 2 includes a first object 3a, a second object 3b, and a third object 3c. In the example of FIG. 2, the first video recording device 10a has a different vantage point of the scene 2 than the second video recording device 10b has of the scene 2. As indicated by the double arrow 20, video data is able to be transmitted from the second video recording device 10b to the first video recording device 10a.

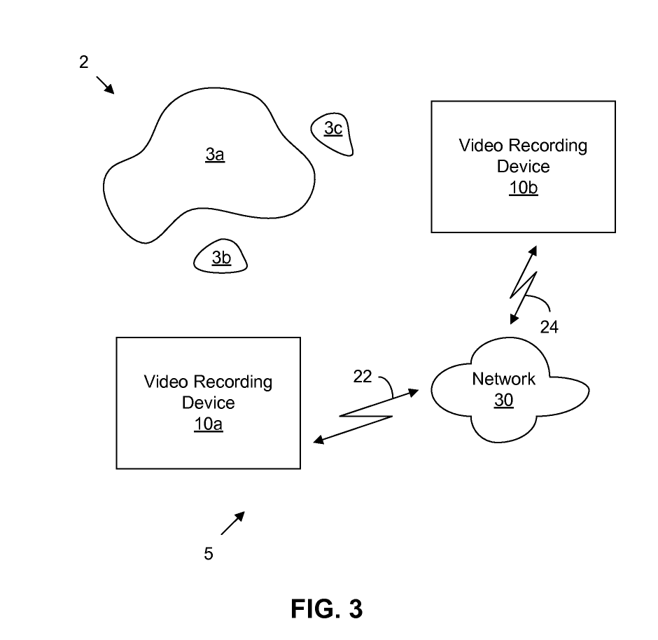

FIG. 3 illustrates an example in which a system 5 in accordance with an embodiment of the present invention is used to create a video of the scene 2. The system 5 is similar to the system 1 (refer to FIG. 1), but the system 5 further includes a network 30, such as a local area network, a wide area network, the Internet, or the like, for transmitting and receiving data. As indicated by the double arrows 22 and 24, the first video recording device 10a and the second video recording device 10b in the system 5 are able to transmit video data between each other through the network 30. In some embodiments, the network 30 comprises the Internet and the first video recording device 10a receives video data from the second video recording device 10b via the Internet.

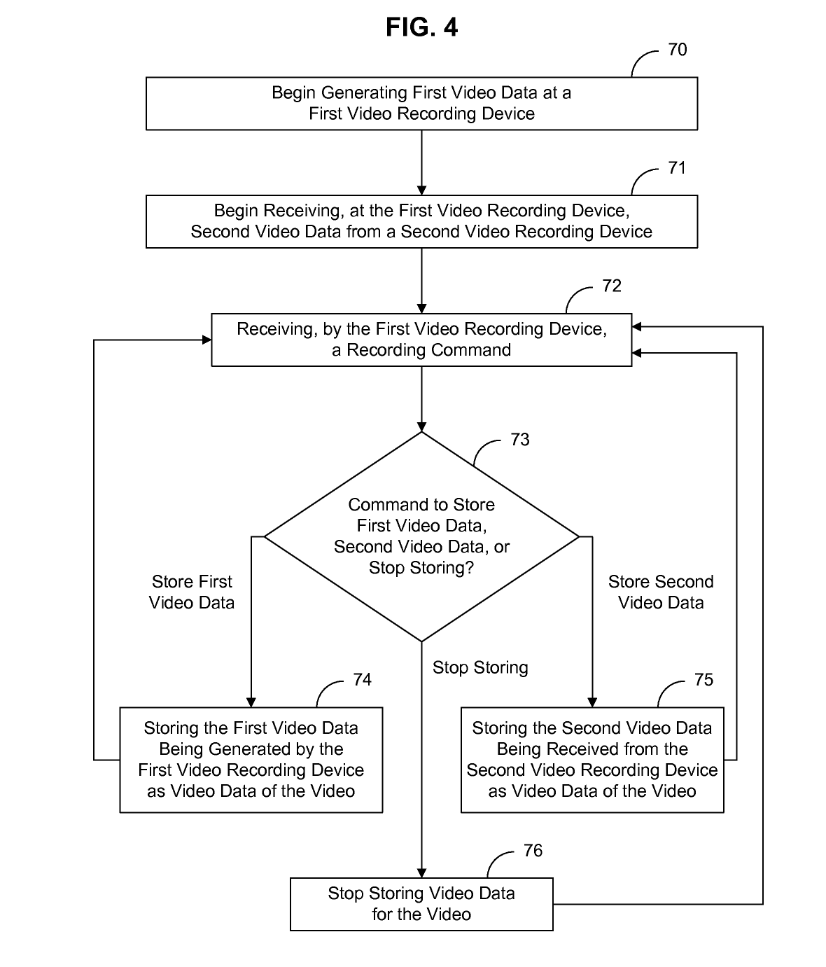

FIG. 4 illustrates a flowchart of a method in accordance with an embodiment of the present invention for storing video data for a video. With reference to FIGS. 1, 2, 3, and 4, in step 70, first video data begins to be generated at a first video recording device. For example, the processing circuitry 13a of the first video recording device 10a may receive image data from the imaging circuitry 11a and audio data from the audio circuitry 12a and may generate first video data from the image data and the audio data. The method then continues to step 71. In step 71, the first video recording device begins receiving second video data from a second video recording device. For example, the communication circuitry 14a of the first video recording device 10a may receive second video data from the communication circuitry 14b of the second video recording device 10b that has been generated by the processing circuitry 13b of the second video recording device 10b using data from the imaging circuitry 11b and the audio circuitry 12b of the second video recording device 10b. In some embodiments, the second video data may be received by the communication circuitry 14a via the network 30, such as the Internet, or the like. The second video data may be passed to the processing circuitry 13a from the communication circuitry 14a after being received by the communication circuitry 14a. The method then continues to step 72.

In step 72, the first video recording device receives a recording command. For example, the first video recording device 10a may receive a recording command from a user through the input device 16a. In some embodiments, the display 15a is a touch display that acts as the input device 16a and the first recording device 10a may receive the recording command from a user through the display 15a. In some embodiments, the first recording device 10a may receive the recording command through the communication circuitry 14a, where the recording command may be issued from an external device, such as the second video recording device 10b due to input from a user at the external device. In various embodiments, the recording command indicates whether to (i) store the first video data being generated by the first video recording device as video data of the video; (ii) store the second video data being received from the second video recording device as video data of the video; or (iii) to stop storing video data for the video. Once the recording command is received, the method continues to step 73.

In step 73, it is determined whether the recording command indicates to (i) store the first video data being generated by the first video recording device as video data of the video; (ii) store the second video data being received from the second video recording device as video data of the video; or (iii) to stop storing video data for the video. In various embodiments, the decision is made by the processing circuitry 13a of the first video recording device 10a.

In a case where it is determined in step 73 that the recording command indicates to store the first video data, the method continues to step 74. In step 74, the first video data being generated by the first video recording device is stored by the first video recording device as video data of the video. For example, the video data generated by the processing circuitry 13a from data obtained from the imaging circuitry 11a and the audio circuitry 12a is stored in the storage device 17a as video data for the video. The method then continues storing the first video data as the video data of the video while waiting in step 72 for another recording command.

In a case where it is determined in step 73 that the recording command indicates to store the second video data, the method continues to step 75. In step 75, the second video data being received from the second video recording device is stored by the first video recording device as video data of the video. For example, the video data received by the communication circuitry 14a of the first video recording device 10a from the communication circuitry 14b of the second video recording device 10b that has been generated by the processing circuitry 13b of the second video recording device 10b using data from the imaging circuitry 11b and the audio circuitry 12b of the second video recording device 10b is stored in the storage device 17a as video data for the video. The method then continues storing the second video data as the video data of the video while waiting in step 72 for another recording command.

If the processing circuitry 13a was storing the first video data into the storage device 17a as video data of the video prior to entering step 75, then upon entering step 75 the processing circuitry 13a switches to start storing the second video data into the storage device 17a as video data of the video. Similarly, if the processing circuitry 13a was storing the second video data into the storage device 17a as video data of the video prior to entering step 74, then upon entering step 74 the processing circuitry 13a switches to start storing the first video data into the storage device 17a as video data of the video.

In a case where it is determined in step 73 that the recording command indicates to stop storing video data for the video, then the method continues to step 76 in which the storing of data is stopped, and the method returns to step 72 to wait for another recording command. In various embodiments, the storing of video data for the video into the storage device 17a is stopped by the processing circuitry 13a in step 76.

Thus, in accordance with various embodiments of the present invention, the first video recording device 10a can generate first video data using the imaging circuitry 11a and the audio circuitry 12a, and can receive second video data using the communication circuitry 14a, and can select in real-time between storing the first video data being currently generated and the second video data being currently received to form a video that is stored in the storage device 17a.

In various embodiments, the first video recording device 10a and the second video recording device 10b are synchronized and provide timestamps or timecodes with each frame of video data generated, and the processing circuitry 13a is configured to store frames in timestamp order when switching between storing the first video data and storing the second video data, so that the cut between the different views in the stored video in the storage device 17a is seamless in time. Also, in some embodiments, the recording commands provided to the first video recording device 10a are also provided to the second video recording device 10b, so that the second video recording device 10b stores the same video in the storage device 17b as is stored by the first video recording device 10a in the storage device 17a. This would allow, for example, for two friends to collaborate in making a video using their video cameras, and for both friends to have a copy of the same video on their camera.

In various embodiments, the display 15a is a split screen and displays the first video data being generated by the first video recording device 10a and the second video data being received by the first video recording device 10a, so that a user of the first video recording device 10a can look at the video data to determine when to make cuts to switch between the two video data streams to store into the storage device 17a as video data for the video.

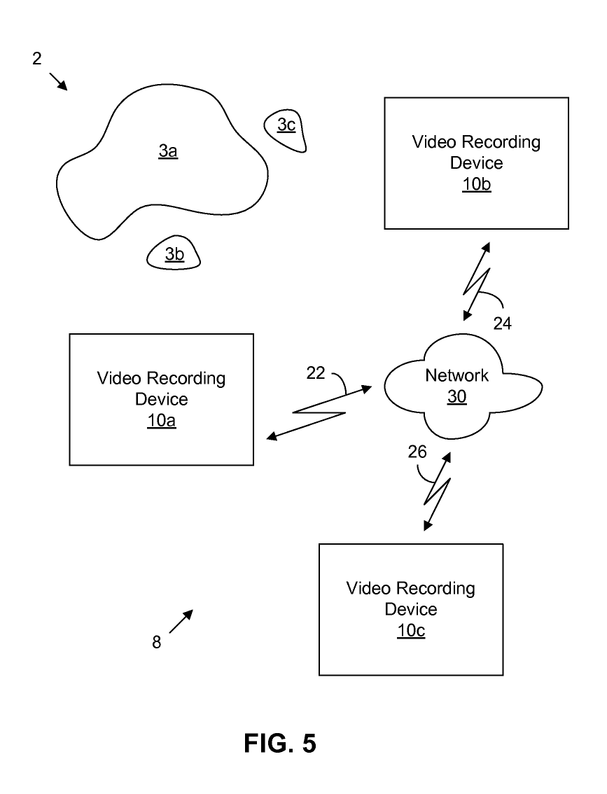

In various embodiments, more than two video recording devices are used to make a video. FIG. 5 illustrates an example of a system 8 in accordance with an embodiment in which three video recording devices 10a, 10b, and 10c are used to make a video of a scene 2. As indicated by the double arrows 22, 24, and 26, the video recording devices 10a, 10b, and 10c may communicate video data between each other while imaging the scene, such as through the network 30. In such embodiments, the video recording device 10a may allow for receiving commands to switch between video data generated by itself or received from any of the other video recording devices to be stored as video data of the video. For example, three friends could image a scene using their respective video cameras, and a video could be created with cuts between the three camera views.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. Various modifications that come within the meaning and range of equivalency of the claims are intended to be within the scope of the invention.

What is claimed is:

1. A video recording device, comprising:
imaging circuitry configured to generate image data for a scene being imaged;
processing circuitry configured to generate first video data using the image data; and
communication circuitry configured to wirelessly send the first video data directly to another video recording device and to wirelessly receive second video data directly from the other video recording device;
the processing circuitry further configured to controllably switch during a recording of a video from storing portions of the first video data as part of the video to storing portions of the second video data as part of the video.

2. The video recording device of claim 1, further comprising:
audio circuitry configured to generate audio data for the first video data.

3. The video recording device of claim 1, further comprising:
a display that is operable to display images of the first video data and the second video data at a same time in a split screen mode.

4. The video recording device of claim 1, further comprising:
a storage device for storing the video.

5. The video recording device of claim 1, further comprising:
an input device for receiving commands to control the processing circuitry.

6. The video recording device of claim 5,
wherein the processing circuitry is configured to switch between storing portions of the first video data as part of the video to storing portions of the second video data as part of the video based on a command received by the input device.

7. The video recording device of claim 1,
wherein the processing circuitry is configured to switch between storing portions of the first video data as part of the video to storing portions of the second video data as part of the video based on a command received by the communication circuitry.

8. The video recording device of claim 7,
wherein the command is received from the other video recording device.

9. The video recording device of claim 1,
the communication circuitry configured to receive the second video data while the imaging circuitry generates the image data.

10. The video recording device of claim 1,
wherein the video recording device is configured to be synchronized with the other video recording device.

11. The video recording device of claim 10,
wherein the first video data and the second video data include timestamps.

12. The video recording device of claim 1,
the communication circuitry configured to wirelessly send the first video data directly to two or more video recording devices at a same time.

13. The video recording device of claim 1,
wherein the video recording device is a hand-held video camera.

14. The video recording device of claim 1,
wherein the video recording device is a cellular phone.

15. A method of using a video recording device, the method comprising:
generating image data using imaging circuitry of the video recording device;
generating first video data from the image data;
wirelessly sending the first video data directly to another video recording device at a same time as wirelessly receiving second video data directly from the other video recording device using communication circuitry of the video recording device; and
controllably switching during a recording of a video from storing portions of the first video data as part of the video to storing portions of the second video data as part of the video.

16. A method of using a video recording device, the method comprising:
generating image data using imaging circuitry of the video recording device;
generating first video data from the image data;
wirelessly sending the first video data indirectly through a network to another video recording device at a same time as wirelessly receiving second video data indirectly through the network from the other video recording device using communication circuitry of the video recording device; and
controllably switching during a recording of a video from storing portions of the first video data as part of the video to storing portions of the second video data as part of the video.
